(19) United States
(12) Patent Application Publication
(10) Pub. No.: US 2017/0214747 A1
(43) Pub. Date: Jul. 27, 2017

(54) COMPUTER-IMPLEMENTED METHOD FOR IMPLEMENTING A V2X APPLICATION AND CORRESPONDING V2X BLOCKS FOR A GRAPHICAL MODELING ENVIRONMENT

(71) Applicant: dSPACE digital signal processing and control engineering GmbH, Paderborn (DE)

(72) Inventors: Sebastian SCHULTE, Meppen (DE); Andreas TENGE, Porta Westfalica (DE)

(73) Assignee: dSPACE digital signal processing and control engineering GmbH, Paderborn (DE)

(21) Appl. No.: 15/413,461

(22) Filed: Jan. 24, 2017

(30) Foreign Application Priority Data
Jan. 26, 2016 (EP) 16152681.9

(51) Int. Cl. H04L 29/08; H04W 76/00

(52) U.S. Cl. CPC H04L 67/12; H04L 67/16; H04W 76/002; H04W 84/005

(57) ABSTRACT

A computer-implemented method for implementing a V2X application on target hardware having a radio adapter is provided. The V2X application is modeled in the form of a block diagram, wherein received telematics data of surrounding objects are recorded in an LDM object list. Detected telematics data of surrounding objects are recorded in a sensor object list, and, by comparing the LDM object list with the sensor object list, a telematics data comparison block determines differential surrounding objects that are recorded only in the sensor object list. For at least one differential surrounding object, a proxy V2X message with the telematics data of this differential surrounding object is created, and the block diagram is translated into a program that can be executed on the target hardware. The program is transferred to the target hardware and executed there, and the proxy message is sent by the target hardware over the radio adapter.

This nonprovisional application claims priority under 35 U.S.C. §119(a) to European Patent Application No. 16152681.9, which was filed in Europe on Jan. 26, 2016, and which is herein incorporated by reference.

### BACKGROUND OF THE INVENTION

Field of the Invention

The invention relates to a computer-implemented method for implementing a V2X application on target hardware having a radio adapter, wherein the V2X application is modeled in the form of a block diagram by means of a graphical modeling environment. The invention also relates to various blocks for use in a graphical modeling environment by means of which a V2X application can be modeled and implemented.

Description of the Background Art

The invention derives from the field of control unit development and relates to the development and testing of control functionality in the broadest sense on a control unit. The term “control functionality” should not be understood in the narrow system theory sense: what is meant is any intentional exertion of influence on a technical process connected to the control unit. This also can be merely the processing and/or fusion of sensor data, for instance from environmental sensors.

The associated development passes through different phases, which are part of the so-called V-model. Normally the desired control functionality is first represented abstractly by a mathematical model as part of offline simulations—no connection to the real process, no real-time requirement—wherein the open-loop and closed-loop control aspect as well as the physical technical process to be influenced are represented mathematically, normally with block diagrams, and are simulated with the aid of numerical methods.

In another step, the control functionality is converted into program code and implemented on target hardware that generally differs greatly from the production control unit that will later be used. The target hardware is typically more powerful than production control units so that it is always ensured that the hardware does not represent a limiting factor in the setup during testing of the control functionality to be implemented. In any event, the target hardware thus instrumented is tested in conjunction with the technical process to be influenced. The target hardware does not necessarily have to differ from the hardware on which the graphical modeling environment is operated and/or with which the translation into an executable V2X program takes place. In this case, the transfer to the target hardware is then extremely short, the program has merely to be loaded and executed. The target hardware can thus also be a PC, including the PC on which the modeling environment is executed and/or on which the translation of the model/block diagram into an executable program takes place.

As soon as the production target hardware, which is to say the production control unit, is available, the control algorithm to be implemented is generated for this target hardware, where the production control unit is not at first tested in conjunction with the actual physical process, but instead with a simulated process environment as part of a hardware-in-the-loop test (HIL test). Once the HIL test has been completed successfully, the target hardware in the form of the production control unit is tested in the real physical process, which is to say in the motor vehicle in the present case, wherein additional adjustments in the parameterization may take place here if applicable.

It is important for all development steps that the abstract control process known from the block diagram—a control functionality in the sense explained above, which can also include a sensor data analysis or data fusion—is no longer translated manually into program code, but instead that this transfer takes place through an automated code generation process from the block diagram. In this way, error-prone manual transfer is avoided, and rapid test cycles with varying control functionality are made possible. The functionality of the block diagrams or of the blocks of the block diagrams themselves can be implemented very differently. It is possible for the functionality of a block diagram to be implemented internally with further block diagrams and blocks of elementary functionality—in sub- and sub-sub-block diagrams and blocks, etc.—, but it is also possible for the functionality of a block diagram itself to be stored in a high-level programming language or description language.

With the graphical modeling and simulation environments in common use today, virtually any desired functionalities can be emulated by using the available elementary operations (basic arithmetic operations, differential and integral operations, bit manipulation, lookup tables, etc.), including, for example, the bus communication between control units or a sensor data analysis and fusion. Also, program code, for example C/C++ or C# code, can be stored in blocks. Examples of development environments that are based on block diagrams include, for example, Simulink (The MathWorks), ConfigurationDesk (dSPACE), ADTF (Automotive Data and Time-Triggered Framework, Elektrobit), or RTMaps (Real-Time Multisensor Advanced Prototyping Software, Intempora).

When it is said that the block diagram is translated into a V2X program that can be executed on the target hardware, this can also mean a program that is interpreted on the target hardware for execution; this, too, is an executable V2X program.

V2X technology is understood as the communication of a vehicle (V=vehicle) with its environment. This may include communication with other nearby vehicles (V2V) or communication with immovable communication partners (V2Infrastructure). The vehicles can be road vehicles, for example, so in this case we can speak of Car2X applications. The environment can involve vehicles of the same type, but can also include different road users (for example VRU=vulnerable road user, such as, e.g., pedestrians, bicycles, wheelchairs). However, the environment can also include other objects and communication systems, including, for example, backend servers in the cloud. A system that uses communication of this nature is also referred to as an intelligent transportation system (ITS).

In an intelligent transportation system, provision can be made that the road users participating in the ITS periodically transmit V2X messages with their telematics data in order to communicate their status to the other road users. The status includes information such as the road user's location, speed, and direction of motion. Such messages are also referred to as cooperative awareness messages (CAM). A road user who receives these CAMs can then maintain a list with all road users from whom he has received a status. Such a list is also referred to as a local dynamic map (LDM). Since not all road users transmit CAMs, in most cases an LDM will not contain all users. As a result of this incomplete database, the road users cannot use all advantages of the ITS optimally.

### SUMMARY OF THE INVENTION

It is therefore an object of the invention to provide a method that makes it possible to obtain a more complete database.

In an exemplary embodiment of the invention a computer-implemented method is provided for implementing a V2X application on target hardware having a radio adapter, wherein the V2X application is modeled in the form of a block diagram by means of a graphical modeling environment, wherein received telematics data of surrounding objects are recorded in an LDM object list, wherein detected telematics data of surrounding objects are recorded in a sensor object list, wherein, by comparing the LDM object list with the sensor object list, a telematics data comparison block determines differential surrounding objects that are recorded only in the sensor object list, wherein, for at least one differential surrounding object, a proxy V2X message with the telematics data of this differential surrounding object is created, wherein the block diagram is translated into a V2X program that can be executed on the target hardware, and the V2X program is transferred to the target hardware and executed there, wherein the proxy V2X message is sent by the target hardware over the radio adapter.

“Received telematics data” can be understood here to mean telematics data that have been received as such by the target hardware, which is to say that have not been reconstructed by the target hardware from other data. Received telematics data can derive from V2X messages from other road users, for example. The received messages assign certain properties to certain objects. These may be time-independent properties like the dimensions, but they may also be time-dependent properties like location or speed. For time-dependent properties, the messages can contain time stamps or a time stamp is assigned to the messages upon reception.

“Detected telematics data” can be understood here to mean telematics data that have been reconstructed by the target hardware from other data. For example, the target hardware may be connected to a sensor. Objects and some properties of the objects, such as, e.g., location or speed, can then be determined from the data of the sensor. Such a sensor may be a radar sensor, an ultrasonic sensor, a video sensor, or a lidar sensor, for example.

The objects in the LDM object list and the sensor object list can be other road users, for example. In other words, passenger cars, trucks, motorcycles, bicycles, pedestrians, wheelchair users, baby carriages, and the like.

In the comparison, the properties of the objects in the object lists can be compared. For example, location, speed, direction of motion, and time stamp of the properties can be compared, and it can be determined from this comparison whether two objects in the two lists describe the same object.

The target hardware itself can include the radio adapter in an integrated hardware solution, but the target hardware can also be connected to a radio adapter through a separately implemented hardware interface. When it is said here that the block diagram created with the graphical modeling environment is translated into a V2X program that can be executed on the target hardware, then this program can be a program that is executable on a processor/microcontroller, but it can also be a hardware description with which a circuit structure is given the desired functionality through hard wiring.

When it is said that the block diagram is translated into a V2X program that can be executed on the target hardware, this can also mean a program that is interpreted on the target hardware for execution; this, too, is an executable V2X program.

It is advantageous that, because of the comparison of the LDM object list with the sensor object list, proxy V2X messages are created only for objects that are not yet included in the LDM object list. Telematics data have obviously already been disseminated for objects that are already included in the LDM object list, and consequently it is unnecessary to send a proxy V2X message for them.

In addition, it is advantageous that other road users receive, by means of the proxy V2X message, the telematics data of an object that apparently is not itself disseminating its telematics data. As a result, the recipients of the proxy V2X message can expand their list of objects in their LDM object list by adding this object. The recipients of the proxy V2X message treat this message like any quite normal V2X message. Thus, if the proxy V2X message is a CAM, it is treated like any other CAM. Consequently, the recipients do not have to be prepared to receive the proxy V2X message, since the proxy V2X message appears to them to be a normal V2X message.

The result with this method is thus that the telematics data of road users who do not themselves send any V2X messages are disseminated through proxy V2X messages that seem like normal V2X messages to the recipients. The dissemination is accomplished through road users or transportation infrastructure that can transmit V2X messages and have the functionality identified above. The number of road users whose telematics data is disseminated through V2X messages is increased by this means, and the efficiency of the ITS as a whole is improved, since more is known about the road users.

In an embodiment, the proxy V2X message is created in such a manner that it appears to the recipients to have been sent by the differential surrounding object itself. To this end, a message is assembled with the data of the differential surrounding object. For example, the data relevant for the V2X applications, such as speed, direction of motion, position, and vehicle type, are appropriately matched to the differential surrounding object. To this end, it is possible, for example, to specify the position of the differential surrounding object in the header of the GeoNetworking protocol instead of the reporting entity's own position. The use of a different signature key for creating the electronic signature of the message is strictly optional.

An advantage of the embodiment is that the recipients of the proxy V2X message do not erroneously assign the telematics data it contains to the sender of the proxy V2X message. The signature typically is only used for an integrity check and it is thus possible to use the same signature key for the proxy message as for the reporting entity's own V2X messages.

In an embodiment, the proxy V2X message can be created by a proxy block, wherein the proxy V2X message contains at least the telematics data of the differential surrounding object.

An advantage is that the formal requirements for creation of the proxy V2X message are decoupled from the comparison of the object lists. If the formal requirements change, for example because the V2X program is to be used in a different ITS with different formal requirements, then only the proxy block must be changed. The telematics data comparison block, in contrast, can be left unchanged.

In an embodiment, the target hardware can be connected to, for example, at least one sensor.

Here, connected includes communicatively connected. The target hardware is thus capable of receiving data from the sensor. These data can be raw data, which is to say the direct measured values of the sensor, as well as processed data, which is to say information about objects and their properties detected by the sensor. A sensor can also be a simulated sensor. In this case, no actual measurement is carried out by a sensor, but instead a simulator supplies data that resemble those of an actual sensor. This can be useful in testing the modeled program when the target hardware is to be tested for correct function by means of a simulator, for example.

The target hardware can receive current data from the sensor and can thus update the telematics data in the sensor object list. In this way, current data are available in the sensor object list for the comparison with the telematics data of the LDM object list.

In an embodiment, the sensor telematics data can be detected by, for example, at least one radar, lidar, ultrasonic, and/or video sensor, and are entered in the sensor object list by the V2X program.

Data from sensors that can detect location, speed, acceleration, object type, or a combination of these properties of objects, are advantageous. These data can then be stored in the sensor object list, and be further processed from there.

In an embodiment, sensor telematics data from different sensors are compared to one another in a data fusion block by the V2X program, and only consistent telematics data are entered in the sensor object list by the V2X program.

The term “consistent telematics data” can be understood here to mean data in which the differences between the data from multiple sensors for the same property of the same object are below a predefined threshold. Such a threshold can be, for example, the measurement accuracy of the sensor or a multiple thereof.

It is an advantage of the improvement that the reliability of the sensor telematics data in the sensor object list can be improved.

In another embodiment, V2X messages with telematics data of other road users are received, in particular from Cooperative Awareness Messages (CAM), and the telematics data are entered in the LDM object list by the V2X program.

The V2X messages can be received over the same radio receiver over which the proxy V2X message is sent, but an additional radio receiver for receiving the V2X messages can also be connected to the target hardware. The V2X messages can be transferred unchanged from the radio receiver to the V2X program, but it is also possible for only the telematics data to be transferred to the V2X program. The receiving of telematics data from other road users can also be simulated. In this case, the simulated V2X messages, or even the simulated telematics data itself, can be transmitted to the V2X program.

The telematics data in the LDM object list can be updated by the received telematics data from the V2X messages. The V2X messages can be assigned to the transmitting object and its telematics data in the LDM object list updated. In this way, current values are available for the comparison with the telematics data from the sensor object list.

In an embodiment, the telematics data of the surrounding objects can be stored in the LDM object list as absolute telematics data.

Absolute telematics data can be understood here to be telematics data that relate to a frame of reference that does not depend on the object. The data are thus specified in relation to an external frame of reference. For example, locations can be specified in relation the GPS grid and speeds can be specified in relation to the stationary surface of the earth.

It is an advantage the absolute telematics data can be processed more easily as a result of the consistent frame of reference, since it is not necessary for the frame of reference of each object to also be known.

According to an embodiment, the telematics data of the surrounding objects are stored in the sensor object list as relative telematics data relative to the sensor's own motion data, and absolute telematics data for the surrounding objects are determined from the relative telematics data of the surrounding objects in the sensor object list and the sensor's own motion data.

The sensor's own motion data are considered here to be, for example, position, speed, and/or acceleration of the sensor. In most cases, data from sensors are acquired relative to the sensor. For comparability of the relative telematics data from the sensor object list and the absolute telematics data from the LDM object list, the telematics data must be converted into a consistent frame of reference. Through simple addition of the sensor data and the sensor's own motion data, the relative telematics data can easily be transformed into absolute telematics data and can subsequently be compared with the absolute telematics data from the LDM object list. The sensor's own motion data can also originate from a simulation of the sensor's own motion. This is advantageous for test purposes, for example.

In an embodiment, the sensor's own motion data can be determined, at least in part, through a global navigation satellite system.

Multiple global navigation satellite systems (GNSS) are known, for example GPS, GLONASS, GALILEO, and Beidou. By means of a GNSS, the position and speed of the receiver of the satellite signal can be determined very quickly and precisely in many cases. A GNSS is thus very well suited for determining the sensor's own motion data. Alternatively or in addition, additional sensors can be used to determine the own motion data. For use in a vehicle, wheel sensors can measure the speed and/or acceleration of the vehicle, for example. Inertial reference sensors can likewise be used for measuring accelerations.

In one embodiment, the proxy V2X message can be created as a Cooperative Awareness Message (CAM).

An advantage of the embodiment is that the form of a CAM is known and is standardized. As a result, the recipients of the proxy V2X message can treat the message like a normal CAM. The recipients thus need not be specifically prepared for receiving the proxy V2X message, but instead must only be capable of processing the known CAMs. Unlike a normal CAM, however, the proxy V2X message does not contain the telematics data of the sending road user, but instead contains the telematics data of the differential surrounding object. In an alternative embodiment, a Basic Safety Message (BSM) can also be used instead of the CAM.

In an embodiment, the target hardware can be arranged in a vehicle.

An advantage of the embodiment is that a vehicle is typically in motion and thus can compare detected telematics data from different locations with received telematics data from different locations.

In an embodiment, the target hardware can be housed in stationary transportation infrastructure.

An advantage of the embodiment is that the stationary transportation infrastructure can monitor a specific area, such as the area of an intersection, on an ongoing basis. The transportation infrastructure can transmit telematics data for this area to distant recipients so that they are informed of the objects in this area before they reach the area.

The invention also relates to a telematics data comparison block for implementing a V2X application in the form of a block diagram by means of a graphical modeling environment, wherein the received telematics data of surrounding objects are recorded in an LDM object list, wherein the detected telematics data of surrounding objects are recorded in a sensor object list, wherein the telematics data comparison block determines differential surrounding objects that are recorded only in the sensor object list by comparing the LDM object list with the sensor object list.

A comparison of telematics data can be carried out simply within the modeling environment by means of the telematics data comparison block, simplifying the modeling of a block diagram. The block recognizes which objects in the two object lists describe the same object, and which objects are only described in the sensor object list. To this end, the telematics data comparison block can, for example, compare the properties of the objects such as location or speed and proceed from the assumption of the same object if the differences between the properties are below a predefined threshold. In other words, the telematics data comparison block can assume the same object if the properties of the object are consistent.

The invention also relates to a proxy message block for implementing a V2X application in the form of a block diagram by means of a graphical modeling environment, wherein the V2X proxy message block creates at least one proxy V2X message with telematics data of a differential surrounding object.

The creation of the proxy V2X message within the modeling environment can be simplified with the proxy message block. The proxy message block accepts the telematics data of the differential surrounding object and creates the proxy V2X message from it, which is to say it ensures that the protocol requirements for a V2X message are fulfilled. Thus it can enter a sender or digitally sign the proxy V2X message, for example.

In an embodiment, the proxy V2X message can be created by the proxy message block in such a manner that the proxy V2X message appears to the recipient to have been sent by the differential surrounding object itself.

The result that the proxy V2X message appears to the recipient to have been sent by the differential surrounding object itself can be achieved by the means, for example, that a different sender is entered into the proxy V2X message than in other V2X messages sent by the target hardware. Also, the proxy V2X message can be signed with a different signature key than other V2X messages sent by the target hardware.

An advantage of the embodiment is that the recipients of the proxy V2X message do not erroneously assign the telematics data it contains to the sender of the proxy V2X message.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a computer-implemented method for implementing a V2X application on target hardware having a radio adapter,

FIG. 2 shows a schematic representation of a computer-implemented method for implementing a V2X application, wherein a proxy message block is used,

FIG. 3 shows a schematic representation of a computer-implemented method for implementing a V2X application on target hardware having a radio adapter, wherein a sensor supplies data to the V2X application,

FIG. 4 shows a schematic representation of a computer-implemented method for implementing a V2X application on target hardware having a radio adapter, wherein two sensors supply data to the V2X application, and

FIG. 5 shows a schematic representation of a computer-implemented method for implementing a V2X application on target hardware having a radio adapter, wherein the V2X application takes into account a sensor's own motion data.

### DETAILED DESCRIPTION

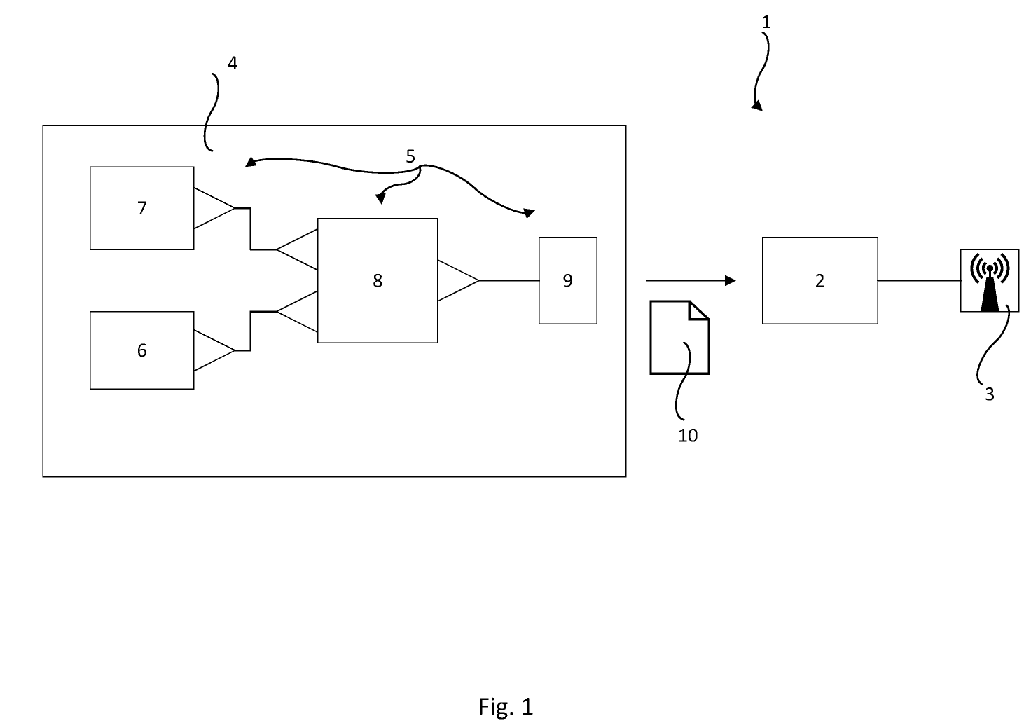

Shown schematically in FIG. 1, firstly, is the sequence of the proposed computer-implemented method 1 for implementing a V2X application on target hardware 2 having a radio adapter 3, wherein the V2X application is modeled in the form of a block diagram 5 by means of a graphical modeling environment 4.

The V2X application modeled as the block diagram 5 accesses an LDM object list 6 and the received telematics data of surrounding objects contained therein. In like manner, the V2X application accesses a sensor object list 7 and the detected telematics data of surrounding objects contained therein. A telematics data comparison block 8 contained in the block diagram 5 determines differential surrounding objects that are recorded only in the sensor object list by comparing the telematics data contained in the lists. A proxy V2X message 9 is created in the block diagram 5 for at least one differential surrounding object.

The block diagram 5 and the V2X application modeled with it are first translated into a V2X program 10 that can be executed on the target hardware 2, and the V2X program 10 is then transferred to the target hardware 2 and executed there. As a whole, this takes place through intermediate steps, for example: the block diagram 5 is analyzed and is first translated into program code, with the program code then being compiled, so that the result is the executable V2X program 10. The V2X program 10 executed on the target hardware 2 thus implements the functionality of the V2X application 10 previously modeled in the form of the block diagram 5 by means of the graphical modeling environment 4.

The proxy V2X message 9 created is sent over the radio adapter 3 during the execution of the V2X program 10 on the target hardware 2.

The radio adapter 3 represents the technical medium used to communicate either with other vehicles or with other communication partners that are stationary such as, e.g., traffic lights, traffic jam reporting stations, etc.

The target hardware creates an ad hoc network together with the other communication partners located within radio range, a network that by its nature is highly variable on account of the continually changing communication partners.

The implementation of a V2X application on the target hardware 2 is facilitated by the use of a telematics data comparison block 8, with which the block diagram 5 is at least partly created. The telematics data comparison block 8 contains an elementary object comparison functionality, with which telematics data can be compared easily. Because the telematics data comparison block 8 brings with it the requisite functionality for comparing telematics data from the two object lists 6, 7, it is no longer necessary to model this functionality in detail with elementary operations of the modeling environment 4.

As telematics data, the object lists 6, 7 contain a multiplicity of properties for each object. These properties can be, for example, motion data such as location, speed, or direction of motion. The telematics data comparison block compares the properties of the objects with one another. If multiple properties of an object from the sensor object list and an object from the LDM object list are essentially the same, then they are considered the same object. It is not necessary for all properties to be essentially the same for two objects to be considered the same object, but it is advantageous if multiple properties must be essentially the same for the objects to be considered the same object. Two properties are considered essentially the same if the difference in the property values is below a predefined threshold. The threshold values for the decision as to whether two properties are essentially the same can be set for each property during modeling in the modeling environment 4. It is also possible to make the threshold value dependent on external conditions. Thus, for example, weather conditions can impair measurements and justify a higher threshold value. If a property of an object in a list has no property value, then this property is not considered for the comparison of the object. If the telematics data comparison block 8 finds no object in the LDM object list that is essentially the same for an object from the sensor object list 7, then it outputs this object as a differential surrounding object.

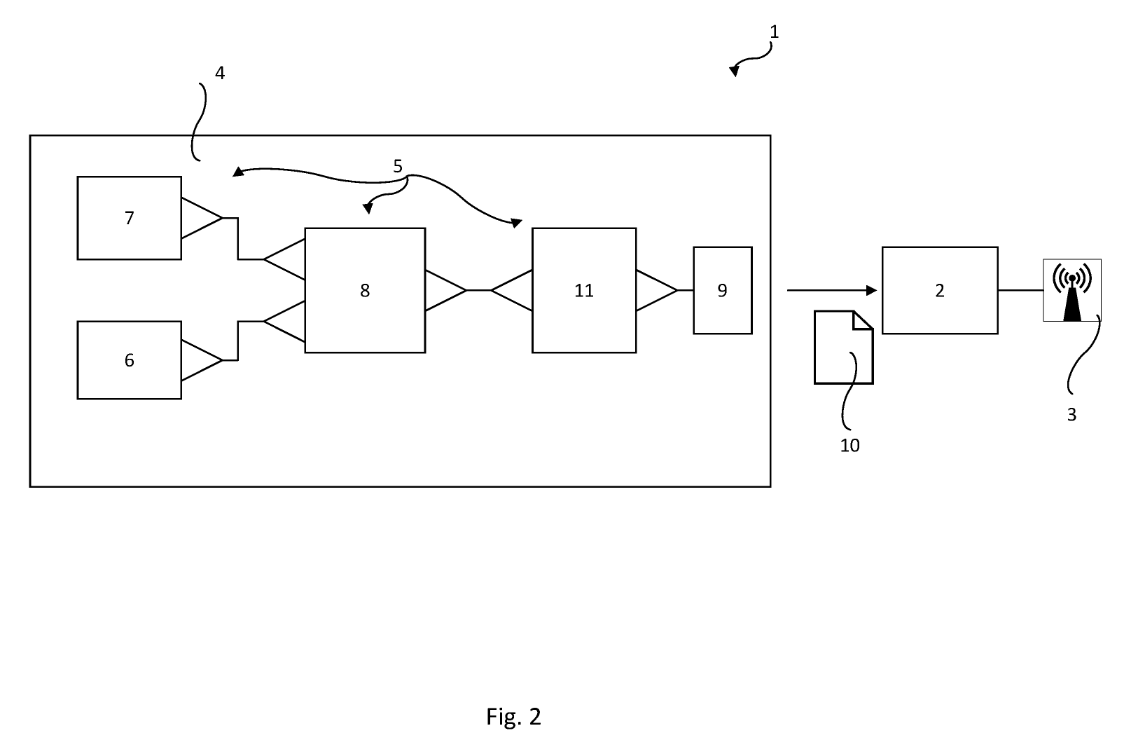

The illustration in FIG. 2 shows another embodiment of the method 1. Only the differences from the illustration in FIG. 1 are explained below. A proxy message block 11 is located in the block diagram 5. The proxy message block 11 accepts the telematics data of a differential surrounding object from the telematics data comparison block 8 and creates a proxy V2X message 9 from the telematics data.

The implementation of a V2X application on the target hardware 2 is facilitated by the use of a proxy message block 11, with which the block diagram 5 is—at least partly—created. The proxy message block 11 contains the requisite functionality for the ability to create a proxy V2X message 9 from the telematics data of a differential surrounding object. Thus, the formal requirements for V2X messages and corresponding signature keys are stored in the proxy message block 11. Because the proxy message block 11 brings this functionality with it, it is no longer necessary to model this functionality in detail with elementary operations of the modeling environment 4.

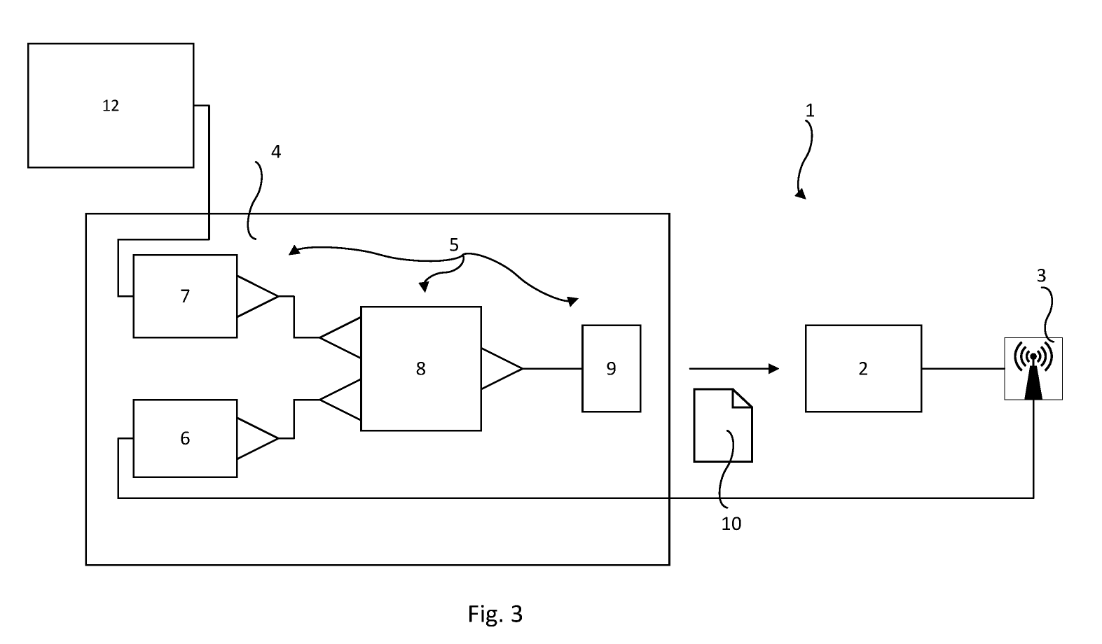

Another embodiment of the method 1 is shown in FIG. 3. Only the differences from FIG. 1 are explained below. A first sensor 12 is communicatively coupled to the sensor object list 7. Shown here is the communicative connection; it is a matter of course that the function of the block diagram 5 shown is executed on the target hardware 2, and the target hardware 2 establishes the communicative connection to the sensor 12. This first sensor 12 can be, for example, a radar sensor, an ultrasonic sensor, a video sensor, or a lidar sensor. The first sensor senses its environment. Objects and their properties in the environment of the first sensor 12 can be identified by means of the sensor data. The properties that can be identified depend on the sensor that is used. The identified objects and their properties are then entered in the sensor object list 7 by the V2X program 10.

The radio adapter 3 is communicatively connected to the LDM object list 6. The radio adapter 3 receives V2X messages from other road users or from the transportation infrastructure. The telematics data contained in the V2X messages received are stored in the LDM object list 6 by the V2X program 10.

The V2X program 10 can update the telematics data in the sensor object list via the communicative connections to the sensor. As a result of receiving V2X messages of other road users, the V2X program 10 can update the telematics data in the LDM object list.

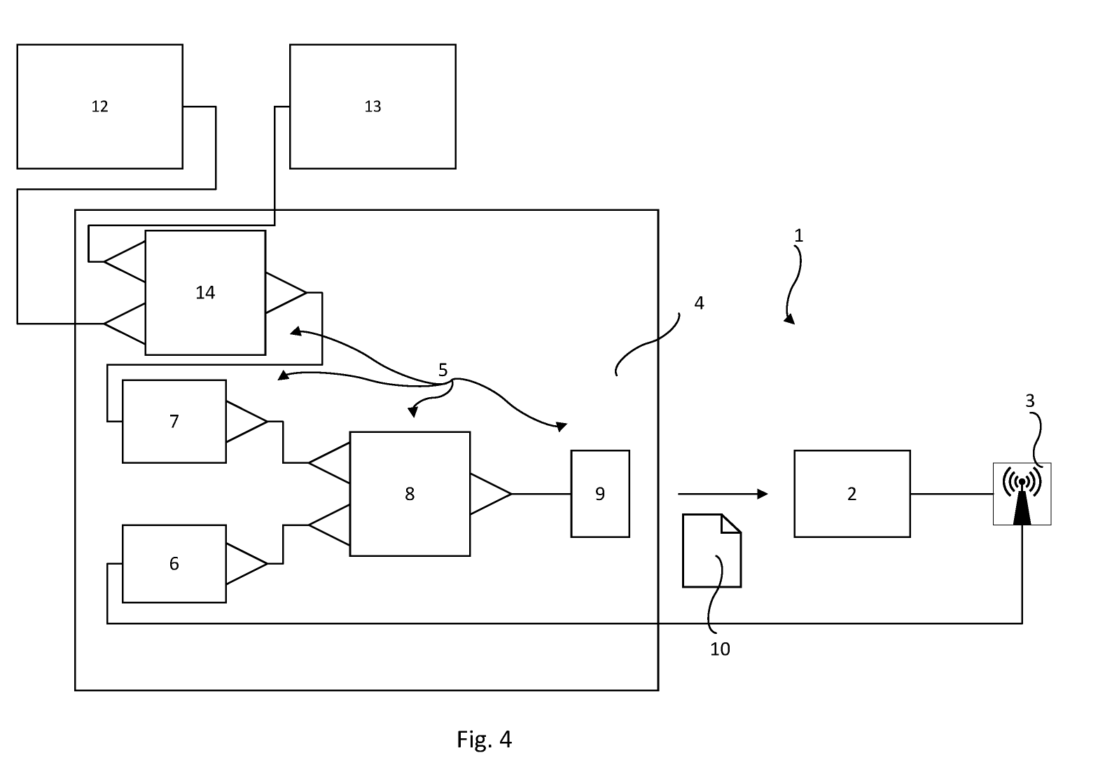

The illustration in FIG. 4 shows another embodiment of the method 1. Only the differences from the illustration in FIG. 3 are explained below. In addition to the first sensor 12, a second sensor 13 is present. The data from the two sensors 12, 13 are transferred to the V2X program 10. In the V2X program 10, the data of the sensors are checked for consistency by a data fusion block 14. During this check, the data fusion block 14 compares the objects identified by means of the sensor data and their properties with one another. If the differences between the objects and their properties are below a predefined threshold, then the data are considered to be consistent. After that, the consistent data are entered in the sensor object list 7 by the data fusion block 14.

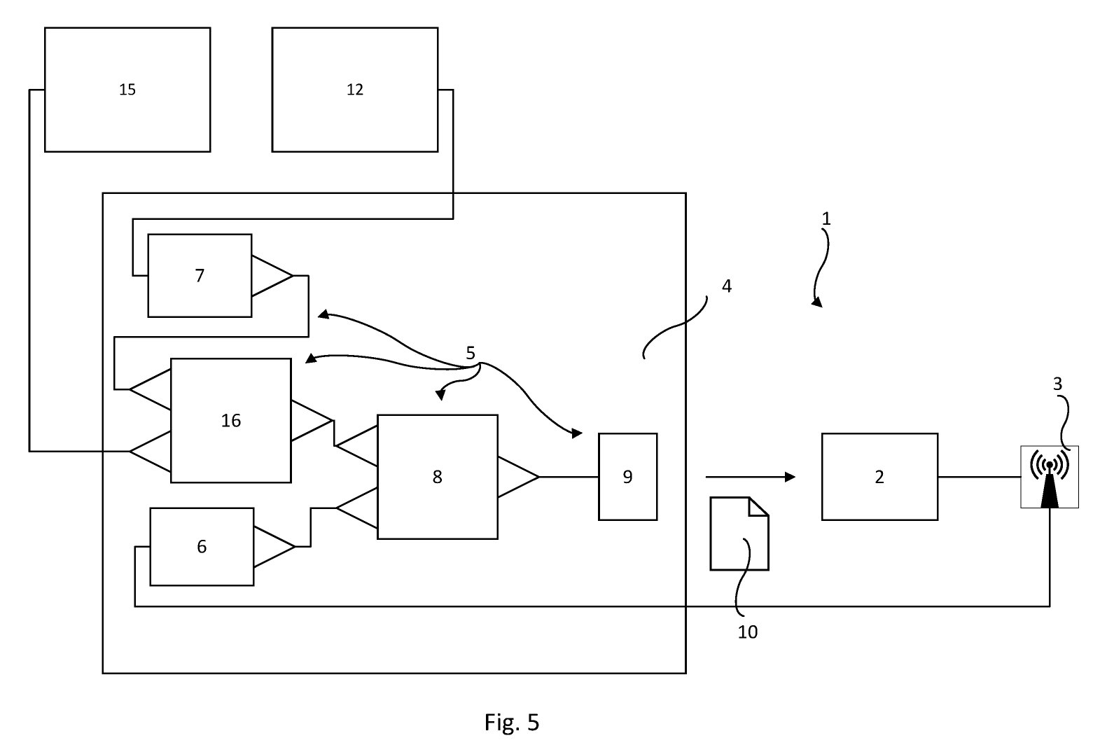

Another embodiment of the method 1 is shown in FIG. 5. Only the differences from FIG. 3 are explained below. In this example, the telematics data transferred from the sensor 12 into the sensor object list 7 are stored as relative data relative to the sensor in the sensor object list 7. The received telematics data in the LDM object list 6, in contrast, are stored as absolute data, which is to say relative to the surface of the earth. In order to be able nevertheless to compare the object lists, the sensor's own motion data 15 are loaded by the V2X program 10. The sensor's own motion data 15 indicate position, speed, acceleration, and/or orientation of the sensor relative to the surface of the earth. By suitable linking of the relative telematics data from the sensor object list 7 with the sensor's own motion data 15, the V2X program 10 can calculate absolute sensor telematics data 16. The absolute sensor telematics data 16 can then be compared with the absolute telematics data from the LDM object list 6 by the telematics data comparison block 8.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for implementing a V2X application on target hardware having a radio adapter, the method comprising:
modeling the V2X application in the form of a block diagram via a graphical modeling environment;
recording received telematics data of surrounding objects in an LDM object list;
recording detected telematics data of surrounding objects in a sensor object list;
comparing the LDM object list with the sensor object list such that a telematics data comparison block determines differential surrounding objects that are recorded only in the sensor object list;
creating, for at least one differential surrounding object, a proxy V2X message with the telematics data of this differential surrounding object;
translating the block diagram into a V2X program that is adapted to be executed on the target hardware; and
transferring the V2X program to the target hardware and executed there, wherein the proxy V2X message is sent by the target hardware via the radio adapter.

2. The computer-implemented method according to claim 1, wherein the proxy V2X message is created such that it appears to recipients to have been sent by the differential surrounding object itself.

3. The computer-implemented method according to claim 1, wherein the proxy V2X message is created by a proxy block, and wherein the proxy V2X message contains at least the telematics data of the differential surrounding object.

4. The computer-implemented method according to claim 1, wherein the target hardware is connected to at least one sensor.

5. The computer-implemented method according to claim 1, wherein the sensor telematics data are detected by radar, lidar, ultrasonic, and/or video sensor, and wherein the telematics data are entered in the sensor object list via the V2X program.

6. The computer-implemented method according to claim 1, wherein sensor telematics data from different sensors are compared to one another in a data fusion block by the V2X program, and only consistent telematics data are entered in the sensor object list via the V2X program.

7. The computer-implemented method according to claim 1, wherein V2X messages with telematics data of other road users are received from Cooperative Awareness Messages (CAM), and wherein the traffic telematics data are entered in the LDM object list via the V2X program.

8. The computer-implemented method according to claim 1, wherein the telematics data of the surrounding objects are stored in the LDM object list as absolute telematics data.

9. The computer-implemented method according to claim 1, wherein the telematics data of the surrounding objects are stored in the sensor object list as relative telematics data relative to the sensor's own motion data, and wherein absolute telematics data for the surrounding objects are determined from the relative telematics data of the surrounding objects in the sensor object list and the sensor's own motion data.

10. The computer-implemented method according to claim 1, wherein the sensor's own motion data are determined, at least in part, through a global navigation satellite system.

11. The computer-implemented method according to claim 1, wherein the proxy V2X message is created as a Cooperative Awareness Message (CAM).

12. The computer-implemented method according to claim 1, wherein the target hardware is housed in a vehicle.

13. The computer-implemented method according to claim 1, wherein the target hardware is housed in stationary transportation infrastructure.

14. A telematics data comparison block for implementing a V2X application as a block diagram via a graphical modeling environment, wherein received telematics data of surrounding objects are recorded in an LDM object list, wherein the detected telematics data of surrounding objects are recorded in a sensor object list, wherein the telematics data comparison block determines differential surrounding objects that are recorded only in the sensor object list by comparing the LDM object list with the sensor object list.

15. A proxy message block for implementing a V2X application as a block diagram via a graphical modeling environment, wherein the V2X proxy message block creates at least one proxy V2X message with telematics data of a differential surrounding object.

16. The proxy message block according to claim 15, wherein the proxy V2X message appears to the recipient to have been sent by the differential surrounding object itself.
